(19) United States
(12) Patent Application Publication
(10) Pub. No.: US 2012/0166113 A1
(43) Pub. Date: Jun. 28, 2012

(54) DETECTING USE OF A PROPER TOOL TO INSTALL OR REMOVE A PROCESSOR FROM A SOCKET

(75) Inventors: Eric E. Pettersen, Raleigh, NC (US); Luke D. Remis, Raleigh, NC (US); William B. Schwartz, Apex, NC (US); Timothy M. Wiwel, Raleigh, NC (US)

(73) Assignee: INTERNATIONAL BUSINESS MACHINES CORPORATION, Armonk, NY (US)

(21) Appl. No.: 12/975,530

(22) Filed: Dec. 22, 2010

(51) Int. Cl. G06F 19/00; H01R 13/64; H01R 3/00

(52) U.S. Cl. 702/57; 439/488; 439/374

(57) ABSTRACT

Method and apparatus to detect use of a manufacturer-approved insertion tool to connect a processor into electronic communication with a land grid array socket on a circuit board of a computer. A baseboard management controller electronically coupled to electrical contacts on the circuit board engages a conductor on the manufacturer-approved insertion tool and records the event.

### BACKGROUND

1. Field of the Invention

The present invention relates to installation and removal of a central processing unit with respect to a land grid array socket on a circuit board.

2. Description of the Related Art

Computers, such as desktop and laptop computers, generally comprise a circuit board to receive and electronically connect with one or more central processing units (CPUs or processors) at one or more CPU sockets on the circuit board. CPU sockets and the processor may be constructed around the pin grid array (PGA) architecture, in which the pins on an underside of the processor are inserted into a PGA socket. To facilitate reliable electrical contact, zero insertion force (ZIF) sockets are usually used, allowing the pins of the processor to be aligned with and then inserted into the PGA socket without resistance and to firmly grip the pins once the processor is connected. If a processor is not properly aligned and connected with the PGA socket, the most likely result will be bent pins on the underside of the processor.

An alternative to the PGA architecture is the land grid array (LGA) architecture in which upwardly-extending pins reside on an LGA socket rather than on the underside of the processor. The upwardly-extending pins contact and electronically communicate with corresponding pads on the bottom of the processor upon connection of the processor with the LGA socket. If the processor is not properly aligned and connected with the LGA socket, the most likely result will be bent pins in the LGA socket that result in failure or impairment of the electronic connection and impaired computer performance. Simply providing a new processor will not alleviate the problem.

A successful connection of a processor to an LGA socket should provide accurate alignment of the pins of the LGA socket with the contact pads on the processor, followed by controlled movement of the processor to connect with the LGA socket. Accurate alignment of the array of contact pads on the underside of the processor with the corresponding array of upwardly-extending pins on the LGA socket is critical. Misalignment may damage the LGA socket and a damaged LGA socket could render the entire circuit board unusable without considerable repair costs.

A processor insertion tool (hereinafter referred to as an “insertion tool”) is a tool used to hold a processor in an aligned position with the LGA socket of a circuit board and to controllably move the processor to connect with the LGA socket. An insertion tool manufactured to connect a processor to a specific LGA socket prevents unwanted pin damage. An insertion tool may also be used to safely remove a processor from the socket.

Untrained or unqualified repair technicians may not have the proper, manufacturer-approved insertion tool to connect a processor in a LGA socket on a circuit board. Alternately, a repair technician may have the insertion tool but may not be properly trained on how to use the insertion tool. As a result, a processor may be poorly connected to the LGA socket and the poor connection may impair the performance of the LGA socket and the circuit board. The owner of the impaired or malfunctioning computer may attempt a warranty claim against the circuit board manufacturer, seeking repair of an LGA socket and related performance problems, when the malfunction was actually caused by the technician's failure to use or to properly use the manufacturer-approved insertion tool.

### BRIEF SUMMARY

An embodiment of a land grid array socket comprises a plurality of upwardly-extending pins to engage corresponding pads on an underside of a processor, and a first electrical contact and a second electrical contact adjacent the plurality of pins and coupled to a baseboard management controller (BMC) to engage a conductor on an insertion tool, wherein the baseboard management controller detects engagement of the first and second electrical contacts with the conductor of the insertion tool in response to use of the insertion tool to connect the processor to the land grid array socket.

An embodiment of a method comprises providing a land grid array socket having first and second electrical contacts on the circuit board, and electronically coupling a baseboard management controller to the first and second electrical contacts, wherein the first and second electrical contacts are disposed in first and second predetermined locations within the land grid array socket to engage first and second electrical contacts on an insertion tool in response to use of the insertion tool to connect a processor to the land grid array socket.

An embodiment of a computer program product including computer usable program code embodied on a computer usable storage medium, the computer program product comprises computer usable program code for detecting a closed circuit between a first electrical contact disposed in electronic communication with a baseboard management controller and a second electrical contact disposed in electronic communication with the baseboard management controller, computer usable program code for recording data on a computer readable storage medium in response to detecting the closed circuit, and computer usable program code for reading and electronically providing the data from the computer readable storage medium in response to receiving an electronically readable inquiry to the baseboard management controller.

In a closely related embodiment comprises computer usable program code for detecting a closed circuit between a first electrical contact disposed in electronic communication with a baseboard management controller and a second electrical contact disposed in electronic communication with the baseboard management controller, computer usable program code for recording data on a computer readable storage medium in response to detecting the closed circuit and for also recording at least one of the date and the time of detection of the closed circuit, and computer usable program code for reading and electronically providing the data and the at least one of the recorded date and time from the computer readable storage medium in response to receiving an electronically readable inquiry to the baseboard management controller.

### BRIEF DESCRIPTION OF THE SEVERAL VIEWS OF THE DRAWINGS

FIG. 1 is a plan view of an embodiment of an LGA socket having a pair of electrical contacts on a circuit board.

FIG. 2 is an elevation view of an embodiment of an insertion tool aligned to connect a processor to an LGA socket on a circuit board.

FIG. 3 is an alternate embodiment of an insertion tool having an electronically detectable identification code stored on a chip disposed in electronic communication with a pair of electrical contacts on the insertion tool.

FIG. 4 is a flowchart of a method in accordance with one embodiment of the invention.

FIG. 5 is a flowchart of a method in accordance with an alternate embodiment of the invention.

### DETAILED DESCRIPTION

One embodiment of the invention provides a method to detect the use of a manufacturer-approved land grid array (LGA) socket insertion tool to connect a processor to an LGA socket on a circuit board. An embodiment of the method comprises providing a circuit board comprising an LGA socket, a first electrical contact and a second electrical contact, connecting a processor to the LGA socket using a manufacturer-approved insertion tool having a conductor, engaging the first and second electrical contacts of the circuit board with the conductor of the insertion tool, and using a baseboard management controller to detect a closed circuit between the first and second electrical contacts of the circuit board through the conductor.

An embodiment of the apparatus of the invention comprises a circuit board comprising an LGA socket having an array of upwardly-extending pins to engage and electronically communicate with an array of contact pads on a processor, and first and second electrical contacts disposed on the circuit board within or adjacent to the LGA socket to engage a conductor on an insertion tool used to connect the processor on the LGA socket of the circuit board. The apparatus further comprises a supervisory processor, such as a baseboard management controller, electronically coupled to the first and second electrical contacts.

An insertion tool may be adapted to cooperate with the apparatus and may comprise first and second electrical contacts conductively coupled one to the other through a conductor so that engagement of the first and second electrical contacts of the insertion tool with the first and second electrical contacts of the circuit board enables the baseboard management controller to electronically detect the presence of the conductor (such as by detecting a closed circuit), which verifies that the insertion tool was used to connect or install (alternately, to disconnect or remove) the processor to (alternately, from) the LGA socket. The insertion tool may comprise a frame coupled through a mechanical linkage to a carriage having a channel to receive the processor and to support the processor along a perimeter edge. The frame may initially be positioned in alignment with the LGA socket and the mechanical linkage may be activated to move the carriage, with a processor received therein, to connect the processor to the LGA socket on the circuit board and to thereby establish electronic communication between the upwardly-extending array of pins of the LGA socket and the corresponding pads on the underside of the processor.

The first and second contacts of the insertion tool may be located in various positions on the insertion tool, so long as the first and second contacts of the insertion tool will necessarily come into contact with the first and second contacts of the circuit board if the insertion tool has been properly used. For example, the first and second contacts of the insertion tool may be positioned on a distal face of the insertion tool frame in order to be aligned with and contact first and second contacts on the circuit board along the perimeter of the LGA socket. Accordingly, the presence of the insertion tool may be detected before, after, or at the exact moment that the processor is connected. In an alternate example, the first and second contacts of the insertion tool may be positioned on the insertion tool carriage in order to be aligned with and contact first and second contacts on the circuit board within the socket immediately adjacent the pin grid array. According to this alternate example, the presence of the insertion tool may be detected in response to the carriage fully extending into the socket, such as through full activation of the mechanical linkage.

The embodiment of the circuit board further comprises one or more alignment structures to guide at least one of the carriage of the insertion tool and the processor to an aligned position with the LGA socket to ensure precise connection of the processor. In addition, the insertion tool may comprise one or more corresponding alignment structures to engage corresponding alignment structures on the circuit board. For example, in one embodiment the circuit board may comprise a plurality of upwardly-extending alignment posts with rounded tips or noses and disposed at the perimeter of the LGA socket to be received into corresponding receptacles or apertures on the insertion tool. Alternately or in addition to the alignment posts, the circuit board may comprise one or more tapered surfaces to engage an edge of a processor to guide the processor towards an aligned position so that the array of pads on the underside of the processor are precisely aligned with the upwardly-extending pins of the LGA socket as the processor is connected.

Another embodiment of the method of the invention is a method to connect a processor in electronic communication with an LGA socket. The method comprises receiving a processor into a carriage of an insertion tool, supporting the processor using the carriage, positioning the insertion tool so that the carriage and the processor supported thereby are aligned with an LGA socket on a circuit board, translating the carriage and the processor to the LGA socket, engaging one or more alignment structures, and conductively engaging an array of contact pads on an underside of the processor with an array of upwardly-extending pins of the LGA socket. In one embodiment, a hold-down force may be applied to the processor while the processor is secured in position with the array of contact pads in contact with the array of pins.

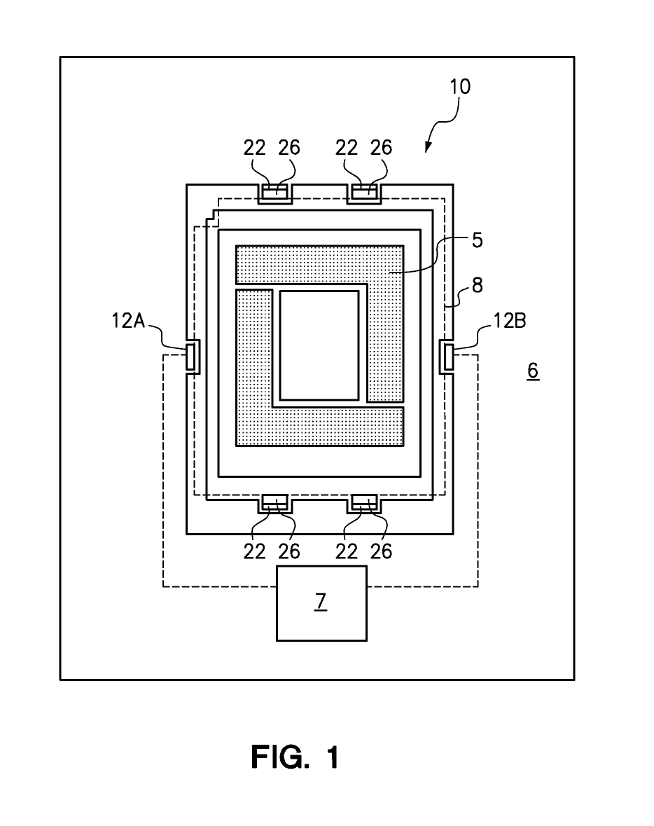

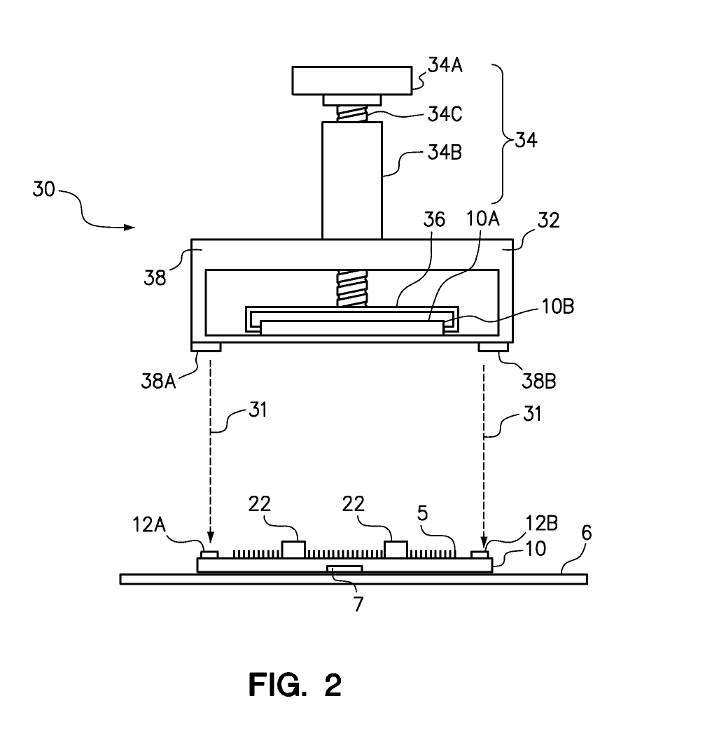

FIG. 1 is a plan view of an embodiment of an LGA socket 10 on a circuit board 6. The LGA socket 10 comprises an array of upwardly-extending pins 5 disposed within the LGA socket 10 to engage a plurality of corresponding pads (not shown) on the underside of a processor (not shown) to be connected to the LGA socket 10. The LGA socket 10 generally defines a target 8 and one or more alignment structures 22 to engage and position a processor (not shown), or a carriage of an insertion tool (see FIG. 2) that receives and holds a processor to be connected to the LGA socket within the target 8. FIG. 1 illustrates four alignment structures 22 comprising a tapered surface 26 to engage and guide a processor or a carriage of an insertion tool (see FIG. 2) toward the insertion tool target 8.

The LGA socket of FIG. 1 further comprises a first electrical contact 12A and a second electrical contact 12B disposed on the circuit board 6 generally adjacent to the plurality of upwardly-extending pins 5 of the LGA socket 10. The first electrical contact 12A and second electrical contact 12B are electronically coupled to a baseboard management controller 7 through a conductive trace on or within the circuit board. The baseboard management controller 7 can detect and record when the first electrical contact 12A and the second electrical contact 12B are disposed in a closed circuit one with the other through a conductor brought into physical engagement with the first electrical contact 12A and the second electrical contact 12B.

FIG. 2 is an elevation view of an embodiment of an insertion tool 30 supporting a processor 10A in a position aligned with the LGA socket 10. The insertion tool 30 comprises a frame 32 movably coupled through a linkage 34 to a carriage 36 that receives and supports a peripheral edge 10B of the processor 10A. The insertion tool further comprises a conductor 38 having a first electrical contact 38A and a second electrical contact 38B. The first electrical contact 38A and the second electrical contact 38B of the insertion tool 30 may be disposed on a metal, metal coated or otherwise conductive portion of the frame 32 which may serve as the conductor 38. Alternately, the first electrical contact 38A and the second electrical contact 38B may be coupled one to the other through a conventional conductor such as, for example, a segment of copper wire (not shown).

The linkage 34 of the insertion tool 30 illustrated in FIG. 2 comprises a crank handle 34A connected to a threaded shaft 34C threadedly received through a sleeve 34B coupled to the frame 32. The carriage 36 that receives and supports the processor 10A is rotatably coupled to an end 34D of the threaded shaft 34C. Rotation of the crank handle 34A and the threaded shaft 34C, for example, using a hand, controllably moves the carriage 36 to or from the threaded shaft 34B. Other linkages may be devised to enable the insertion tool 30 to movably couple the carriage 36 to the frame 32 and to provide controlled movement of the carriage 36 and the processor 10A relative to the LGA socket 10. The preferred movement of the carriage is substantially vertically translational with respect to the pin grid array 5 within the socket 10 on the circuit board.

The electrical contacts 38A and 38B of the insertion tool 30 are illustrated as vertically aligned with the corresponding electrical contacts 12A and 12B of the LGA socket 10. FIG. 2 illustrates how the spacing of the electrical contacts 38A and 38B of the insertion tool 30 corresponds to the spacing of electrical contacts 12A and 12B of the circuit board 6. There is no requirement that the electrical contacts 38A and 38B of the insertion tool 30 and the corresponding electrical contacts 12A and 12B of a circuit board 6 be arranged with the particular spacing shown or in any particular position on the circuit board 6, and the arrangement illustrated in FIG. 2 is merely one possible arrangement of many. For example, the electrical contacts 12A and 12B of a circuit board 6 may be disposed at the periphery of the array of upwardly-extending pins 5, within the pin array 5, or outside the LGA socket 10, but may be disposed anywhere on the circuit board 6 that can be engaged by contacts on the insertion tool 30 during connection or removal of the processor chip 10A.

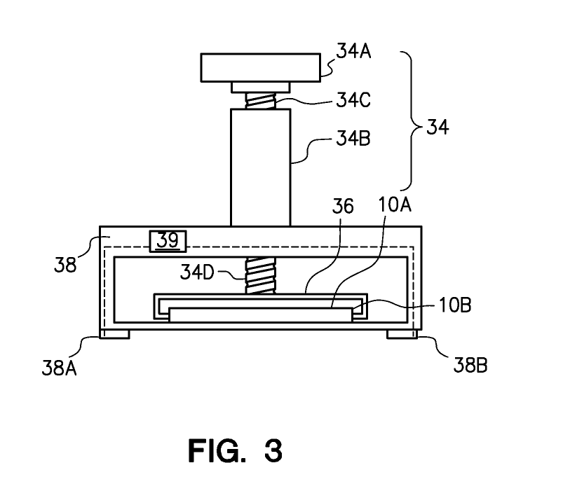

FIG. 3 is an alternate embodiment of an insertion tool 30 having an electronically readable identification code or signal stored on a memory chip, other memory device, or analog circuit 39 disposed in electronic communication with the electrical contacts 38A and 38B. The identification code may be read by the baseboard management controller 7 of FIGS. 1 and 2 in response to engagement of the electrical contacts 38A and 38B of the insertion tool 30 with the electrical contacts 12A and 12B of the LGA socket 10 to enable the identification of the insertion tool 30 used to connect (or remove) the processor chip 10A with (from) the LGA socket 10.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

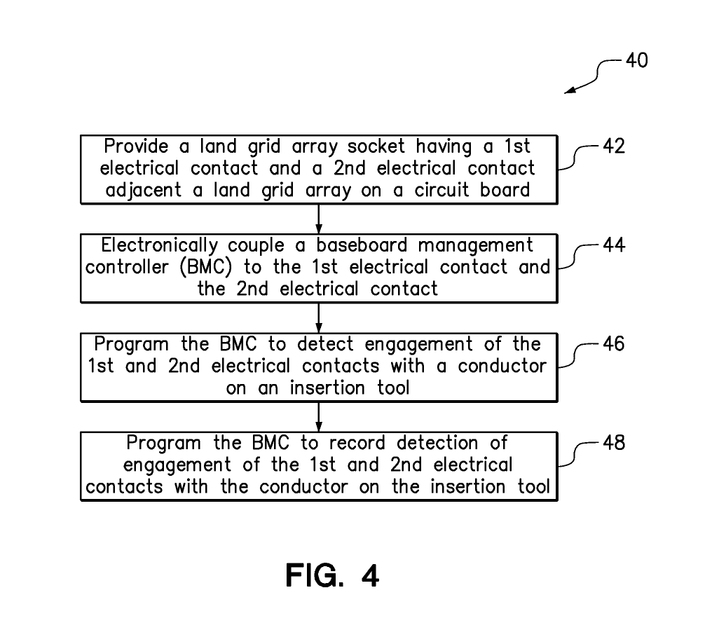

FIG. 4 is a flowchart of a method 40 in accordance with one embodiment of the invention. The flowchart illustrates the step 42 of providing a land grid array socket having a first and second electrical contact adjacent a land grid array on a circuit board, the step 44 of electronically coupling a baseboard management controller to the first and second electrical contacts, the step 46 of programming the baseboard management controller to detect engagement of the first and second electrical contacts with a conductor on an insertion tool and the step 48 of programming the baseboard management controller to record the detection of engagement of the first and second electrical contacts with the conductor on the insertion tool.

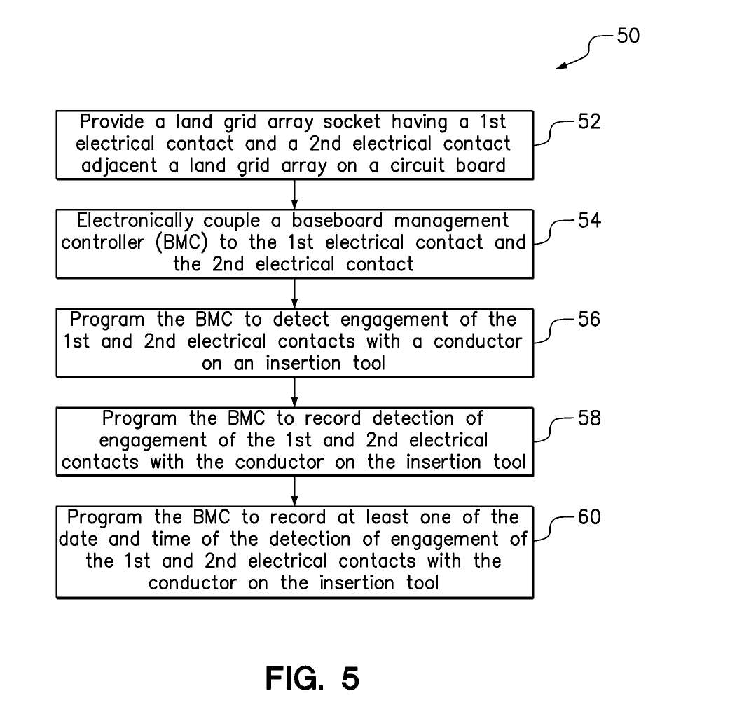

FIG. 5 is a flowchart of an alternate method 50 in accordance with a modified embodiment of the invention illustrated in FIG. 4. The flowchart illustrates the step 52 of providing a land grid array socket having a first and second electrical contact adjacent a land grid array on a circuit board, the step 54 of electronically coupling a baseboard management controller to the first and second electrical contacts, the step 56 of programming the baseboard management controller to detect engagement of the first and second electrical contacts with a conductor on an insertion tool and the step 58 of programming the baseboard management controller to record the detection of engagement of the first and second electrical contacts with the conductor on the insertion tool followed by the step 60 of recording at least one of the time and the date of the detection of the engagement of the first and second electrical contacts with the conductor.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A land grid array socket, comprising:
a plurality of upwardly-extending pins to engage corresponding pads on an underside of a processor; and
a first electrical contact and a second electrical contact adjacent the plurality of pins and coupled to a supervisory controller to engage a conductor on an insertion tool;
wherein the supervisory controller detects engagement of the first and second electrical contacts with the conductor of the insertion tool in response to use of the insertion tool to connect the processor to the land grid array socket.

2. The land grid array socket of claim 1, further comprising:
one or more alignment structures to guide the processor to an aligned position with the land grid array socket.

3. The land grid array socket of claim 2, wherein the one or more alignment structures comprises at least one of the first and second electrical contacts of the land grid array socket.

4. The land grid array socket of claim 1, wherein the supervisory controller is a baseboard management controller.

5. The land grid array socket of claim 4, wherein the baseboard management controller is programmed to read and store an identification code stored on a chip on an insertion tool used to connect the processor; and
wherein the baseboard management controller reads an identification code stored on the chip in response to engagement of the first and second electrical contacts of the land grid array socket with corresponding first and second electrical contacts of the insertion tool.

6. A method, comprising:
providing a land grid array socket having a first and second electrical contacts on the circuit board;
electronically coupling a baseboard management controller to a first electrical contact and a second electrical contact;
providing computer usable code to enable the baseboard management controller to detect the engagement of the first electrical contact and the second electrical contact with a conductor.

7. The method of claim 6, further comprising:
engaging one or more alignment structures on the circuit board with the insertion tool to position the processor in the carriage in an aligned position with the land grid array socket.

8. The method of claim 7, further comprising:
disposing at least one of the first and second electrical contacts of the land grid array socket on one or more alignment structures.

9. The method of claim 6, further comprising:
electronically storing an identification code on a chip disposed in electronic communication with the first and second electrical contacts on the conductor;
programming the baseboard management controller to read and store an identification code;
engaging the first and second electrical contacts of the land grid array socket with corresponding first and second electrical contacts of the insertion tool.

10. The method of claim 6, further comprising:
storing data relating to the engagement of the conductor with the first and second electrical contacts of the LGA socket.

11. The method of claim 10, further comprising:
storing data relating to the time of detection of the engagement of the conductor with the first and second electrical contacts of the land grid array socket.

12. A computer program product including computer usable program code embodied on a computer usable storage medium, the computer program product comprising:
computer usable program code for detecting a closed circuit between a first electrical contact disposed in electronic communication with a baseboard management controller and a second electrical contact disposed in electronic communication with the baseboard management controller;
computer usable program code for recording data on a computer readable storage medium in response to detecting the closed circuit; and
computer usable program code for reading and electronically providing the data from the computer readable storage medium in response to receiving an electronically readable inquiry to the baseboard management controller;
wherein the first and second electrical contacts are disposed on a circuit board adjacent a land grid array socket to engage a conductor on an insertion tool used to connect a processor to the land grid array socket.

13. The computer program product of claim 12, further comprising:
computer usable program code for reading an insertion tool identification code stored on and readable from a computer readable storage medium on an insertion tool.

14. The computer program product of claim 13, wherein the data recorded on the computer readable storage medium in response to detecting the closed circuit comprises the insertion tool identification code.

15. The computer program product of claim 14, wherein the data recorded on the computer readable storage medium in response to detecting the closed circuit further comprises at least one of the date and time of detection.

16. The computer program product of claim 12, wherein the data recorded on the computer readable storage medium in response to detecting the closed circuit comprises at least one of the date and time of the detection.
